(19) United States
(12) Patent Application Publication
(10) Pub. No.: US 2014/0122182 A1
(43) Pub. Date: May 1, 2014

(54) SYSTEM AND METHOD FOR ASSESSING PRODUCT MATURITY

(71) Applicant: TATA CONSULTANCY SERVICES LIMITED, Mumbai (IN)

(72) Inventors: Suresh CHERUSSERI, Mumbai (IN); Manoranjan PANDA, Bhubaneswar (IN); Gururaj ANJAN, Bhubaneswar (IN)

(73) Assignee: TATA CONSULTANCY SERVICES LIMITED, Mumbai (IN)

(21) Appl. No.: 13/773,424

(22) Filed: Feb. 21, 2013

(30) Foreign Application Priority Data
Nov. 1, 2012 (IN) 3173/MUM/2012

(51) Int. Cl. G06Q 30/02

(52) U.S. Cl. CPC G06Q 30/0203
USPC 705/7.32

(57) ABSTRACT

A method and system to evaluate maturity level of a software product is provided wherein the evaluation is based on four maturity levels, the maturity levels being Basic, Established, Differentiated, and Leadership in dimensions of key focus areas namely Product planning, Technology Tools & Methodology, Product Code & Quality, Release & Configuration Management, Usability, Security & Supply chain, and Intellectual Property Rights, and competency areas of Process, Infrastructure, Architecture, and People. A checklist having plurality of conformance requirements is provided at each maturity level for each key focus area to assess the maturity level of the software product.

This application claims the benefit of Serial No. 3173/MUM/2012, filed 1 Nov. 2012 in India and which application is incorporated herein by reference. To the extent appropriate, a claim of priority is made to the above disclosed application.

### FIELD OF THE INVENTION

The present invention relates generally to a method and system for evaluating maturity level of a software product. More specifically, the present invention relates to assessment of maturity level of a software product based on four maturity levels, seven key focus areas, and aligned with four competency areas.

### DESCRIPTION OF THE RELATED ART

Product development within stipulated time, cost and quality has always posed a formidable challenge for the software industry. Several development methodologies along with automated tools are being used to engineer the product, also essential for the team is to follow a discipline method supported by processes, guide to architecture centric development, and adoption of product line approach, mindset for interoperable product, infrastructure and right People to engineer the product. Several methods have come up with automated tools to assess maturity level of a software product; however no known assessment methods and system teaches an approach that is supported and focused on key competency areas that include Process, Architecture, Infrastructure and People. Further, no such evaluation model is known to exist in the art that teaches assessment of software maturity based on a defined degree of maturity levels and key focus areas.

In view of the aforementioned limitation of the prior art, it would be desirable to have a system to assess maturity level of a software product based on most appropriate maturity levels, key focus areas and key competency areas.

### SUMMARY OF THE INVENTION

Embodiments of the present invention overcome shortcomings of prior software product maturity systems to evaluate a software product. The invention is derived from four maturity levels of Basic, Established, Differentiated and Leadership, and further derived from seven key focus areas, the key focus areas being Product planning, Technology Tools & Methodology, Product Code & Quality, Release & Configuration Management, Usability, Security & Supply chain, and Intellectual Property Rights.

An objective of the invention is to provide a systematic method and a system to assess maturity level of a software product, wherein the assessment includes providing an exhaustive checklist based on seven key focus areas to derive an optimum maturity level of the software product.

Another objective of the invention is to provide a systematic method and a system for identifying maturity levels and key focus areas to maximize alignment with four competency areas of Process, Architecture, Infrastructure and People.

According to an exemplary embodiment of the present invention, provided is a method to evaluate maturity level of a software product, the method comprising: providing a category weightage to at least one key focus area (KFA) at least one maturity level, the weightage being based on its significance at a particular maturity level;

providing by at least one assessor product maturity model ratings based on ratings score calculated for each KFA based on a predefined checklist comprising of at least one question of a questionnaire;
calculating the maturity score of the each KFA based on the ratings score and the category weightage of said at least one KFA; and
for the maturity score for each level determined above a threshold score, aggregating the maturity score to the maturity scores determined for each maturity level below said level to obtain a single product maturity score, wherein at least one of the providing, calculating, and aggregating is performed by a processor.

In another embodiment, the system for evaluating maturity level of a software product at least one maturity level, the maturity score being computed in terms of at least one Key focus (KFA) area, at least one competency area, at least one maturity level, and at least one assessment reading, the system comprising:

a memory; and
a processor coupled to the memory configured to execute software instructions to cause following steps:
providing a category weightage to at least one key focus area (KFA) for at least one maturity level, the weightage being based on its significance at a particular maturity level;
providing by an assessor product maturity model ratings based on ratings score calculated for each KFA based on a predefined checklist comprising of at least one question of a questionnaire;
calculating the maturity score of that KFA based on the ratings score and category weightage of said at least one KFA; and
for the maturity score for each level determined above a threshold score, aggregating the maturity score to the maturity scores determined for each maturity level below said level to obtain a single product maturity score.

### BRIEF DESCRIPTION OF THE DRAWINGS

The above-mentioned and other features and advantages of the various embodiments of the invention, and the manner of attaining them, will become more apparent and will be better understood by reference to the accompanying drawings, wherein:

FIG. 1 is a schematic view of a software product maturity model depicting four maturity levels, seven key focus areas, and four competency areas.

FIG. 2 shows schematically the steps in applying the evaluation process to a single level of a software product, according to the present invention.

### DETAILED DESCRIPTION

It is to be understood that the invention is not limited in its application to the details of construction and the arrangement of components set forth in the following description or illustrated in the drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

Embodiments of the present invention are described below with reference to flowchart illustrations and/or block diagrams of methods and apparatus (systems). It will be understood that each block of the flowchart illustrations and/or block diagrams, and/or combinations of blocks in the flowchart illustrations and/or block diagrams, can be implemented by computer program instructions. These computer program instructions may be provided to a processor of a general purpose computer, special purpose computer, or other programmable data processing apparatus to produce a “particular” machine, such that the instructions, which execute via the processor of the computer or other programmable data processing apparatus, create “particular” means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce a product including instruction means which implement the function/act specified in the flowchart and/or block diagram block(s). Alternatively, computer program implemented steps or acts may be combined with operator or human implemented steps or acts in order to carry out an embodiment of the invention.

The purpose of the procedure illustrated is to establish the maturity level assessment of a software product and to analyze the level where exactly the software product fits in within the four maturity levels of Basic, Established, Differentiated, and Leadership. These four maturity levels are organized in a hierarchical manner such that the maturity level of a software product increases as the maturity level move from one maturity level to another in ascending order.

The maturity level of the software product is measured primarily with respect to four key competency areas, namely: the processes it follows and complies with, architecture it adopts, interoperability standards, and infrastructure and people perspective.

A preferred embodiment of the present invention is directed to a method and system for measuring maturity levels of a software product by utilizing a multidimensional product maturity model (PMM) that provides suggestive direction or path to achieve product maturity. The holistic model, herein, evaluates the product maturity talking into account various dimensions for product excellence.

The model provides a roadmap for the product team to achieve product excellence in the dimension of process, architecture, infrastructure and people across seven key focus areas vis a vis product planning; technology, tools and methodology; product code and quality; release and configuration management; usability, security and performance; secure engineering and supply chain; and intellectual property rights. The evaluation is goal driven wherein each maturity level has a goal statement that is further evaluated based on a specific goal of each key focus area within that maturity level.

The preferred embodiment of the present invention defines four maturity levels of Basic, Established, Differentiated and Leadership contained within the product maturity model, as:

Basic Level:

The methodologies, technologies and tools for the development of the product are identified within this level. Project management processes are established to track cost, schedule, and functionality. Architecture centric development process is defined and reference architecture is finalized. Well defined approach for supporting multiple standards, protocol and integrating in a loosely coupled fashion with internal session also gets defined. The group acquires the capability to provide life cycle service (Analysis, Design, Development, Deployment and Support). The organization has significant number of consultants experienced in this technology. Training and certification standards and requirements are documented. Awareness for Product line approach for product development is created; reuse philosophy being adopted by the group. Basic infrastructure for development and hosting is documented.

Established Level:

The methodologies, technologies and tools for the development of the product are standardized, and integrated into a standard process. All work projects use an approved, tailored version of the standard process for developing and maintaining software. Detailed measures of the software process and product quality are documented and collected. Both the software process and products are quantitatively understood and controlled.

The group here, shows action and commitment to incorporate software product lines in its' strategic plans and future direction. Overall, the group understands the importance of software product lines in achieving its strategic goals. The group aligns their business practices with product line engineering and product line practices gets documented and established. Reviews, management monitoring activities are in place to ensure adherence to project management activities. Reference architecture is in place, deployed, and adherence to reference architecture validated.

Product toll gates are established and product reviews conducted as per toll gates defined. Maturity of the product is ascertained using Product Maturity Model. The group has internalized and established the processes for development and secure engineering.

The group conducts advanced training and defines process for sharing the knowledge within the organization. A process is in place to track changes in the technology and market movements. The manpower quality and quantity is brought aboard and trained as per the standards established Infrastructure for development and hosting is established.

Differentiated Level:

Continuous process improvement is enabled by quantitative feedback from the process and from piloting innovative ideas and technologies. The product has industry/functional specific offerings related to the solution addressed by the product, each of them being deployed and considered as a key differentiator. A significant number of “Customer Quotes” is available describing the strength of the group and the value it brings to the customer. The Group practices Product line approach for product development, core assets base being created by the group as part of reuse adoption.

Assets are well documented, reviewed and shared with customer on need basis. The group regularly participates and contributes in Industry/Technical conferences and workshops.

Leadership Level:

The products are cited in comparisons, reviews by experts and covered in industry magazines regularly. They are rated in international comparison charts and their features set the benchmark for the market. The competitors consider the product line of the organization as a direct threat to their business. The Group exhibits the characteristics of early movers or even pioneers in product development.

Regular invitation to international conferences and workshops as speaker is made. Global alliance with technology vendor (with highest level of partnership agreement) and revenue generation through the alliance is established. Evaluation and high rating is done by established/recognized international agencies. The products have built in proprietary tools that are used as solution accelerator in enhancing cost-benefits to the customers. The group publishes its research and market studies in premier international journals.

The group has specialized training program to institutionalize offerings. The group has research methodology at place for continuous improvement on all fronts. The group partners with alliances in complementing product development. Model to provided hosted infrastructure also gets deployed.

Now, the following detailed description refers to the accompanying drawings which illustrate specific embodiments in accordance to the present the invention. Other embodiments having different structures and operations do not depart from the scope of the present invention.

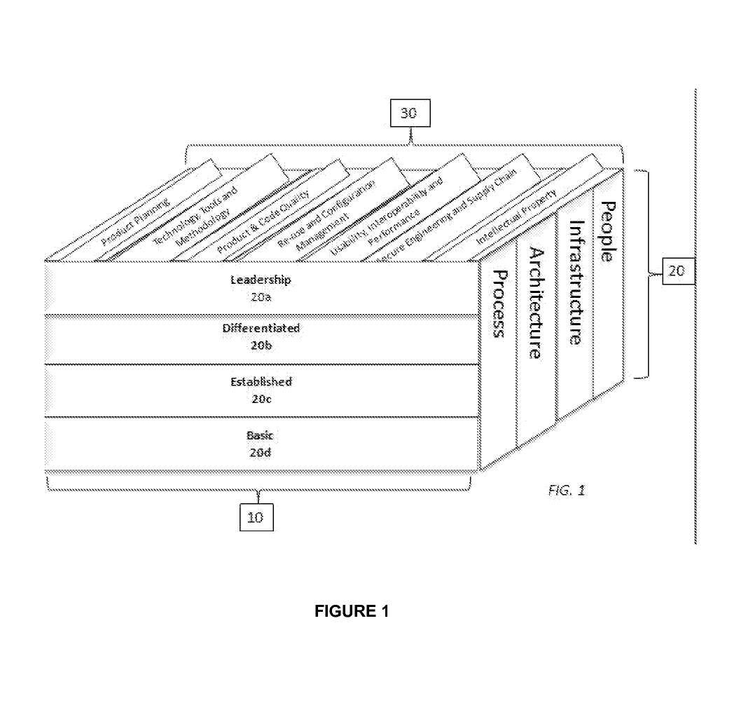

FIG. 1 is a block schematic representation of basic product maturity model 100 for measuring product maturity levels (10) as either of Basic (10a), Established (10b), Differentiated (10c) and Leadership (10d) in dimensions of key competency areas (20) namely process (20a), architecture (20b), infrastructure (20c) and people (20d); across seven key focus areas (30) namely product planning (30a); technology, tools and methodology (30b); product code and quality (30c); release and configuration management (30d); usability, security and performance (30e); secure engineering and supply chain (30f); and intellectual property rights (30g).

Next, a relational mapping between key competency areas (20) and key focus areas (30) that serves as a basis for measuring product maturity levels is presented in Table 1 below.

TABLE 1

| | | | | |
|---|---|---|---|---|
| Level | Process (20a) | Architecture (20b) | Infrastructure (20c) | People (20d) |

A) Product Planning (30 a)

| | | | | |
|---|---|---|---|---|
| Basic | | Architecture | Infrastructure | Training needs |
| (Level 1) | | related activities | Planning is in place | has been |
| | | planned, | Infrastructure | identified, |
| | | architecture vision | budget approved” | training plan |
| | | defined, | | has been |
| | | architecture Team | | developed for |
| | | available | | the product |
| | | Solution | | team |
| | | Architecture | | Awareness of |
| | | defined | | Product Line |
| | | | | approach has |
| | | | | been created |
| Established | Product | Complete | Infrastructure for | The group |
| (Level 2) | roadmap | enterprise | development and | conducts |
| | defined and | architecture | hosting has been | advanced |
| | reviewed, | description done | planned | training and |
| | Product toll | Principles that | | has defined |
| | gates | govern the | | process for |
| | established, | architecture | | sharing the |
| | Product | process, govern | | knowledge |
| | planning | the | | within the |
| | activities are | implementation of | | organization |
| | automated | architecture is in | | The manpower |
| | through usage | place | | quality and |
| | of tools | Architecture blue | | quantity has |
| | Product using | print defined | | been brought |
| | tailored version | Architecture | | aboard and |
| | of the standard | review process is | | trained as per |
| | processes, | in place and | | the standards |
| | Product line | practiced | | establish |
| | approach has | No architecture | | |
| | been | assessment review | | |
| | established | comments beyond | | |
| | Both the | 30 days | | |
| | software | Reference | | |
| | process and | architecture | | |
| | products have | defined, Enterprise | | |
| | been | Continuum is | | |
| | quantitatively | being practiced | | |
| | (metrics) | | | |
| | understood and | | | |
| | controlled | | | |
| | Defect analysis | | | |
| | conducted | | | |
| Differentiated | Product | Architecture | Infrastructure | The group has |
| (Level 3) | reviews | review of product | benchmarking | specialized |
| | happens as per | is established | | training |
| | toll gates | No gap between | | program to |
| | Continuous | baseline and target | | institutionalize |
| | process | architecture | | offerings. |
| | improvement is | Architecture | | The group |
| | enabled by | change | | regularly |
| | quantitative | management | | participates |
| | feedback from | process is in place | | and contributes |
| | the process | | | in Industry/ |
| | A significant | | | Technical |
| | number of | | | conferences |
| | “Customer | | | and |
| | Quotes” is | | | workshops. |
| | available | | | The group has |
| | describing the | | | research |
| | strength of the | | | methodology |
| | group and the | | | at place for |
| | value it brings | | | continuous |
| | to the customer | | | improvement |
| | Core assets | | | on all fronts. |
| | base has been | | | The group |
| | created by the | | | partners with |
| | group as part of | | | alliances in |
| | reuse adoption | | | complementing |
| | Product is | | | product |
| | benchmarked | | | development |
| | in market place | | | |
| Leadership | The products | Architecture is | Leadership in | The group |
| (Level 4) | are cited in | mature and market | infrastructure | published its |
| | comparisons, | leader | | research and |
| | reviews by | Product is in | | market studies |
| | experts and | magic quadrant of | | in premier |
| | covered in | leading analyst | | international |
| | industry | report | | journals. |
| | magazines | | | |
| | regularly. | | | |
| | They are rated | | | |
| | in international | | | |
| | comparison | | | |
| | charts and their | | | |
| | features set the | | | |
| | benchmark for | | | |
| | the market | | | |
| | Product is in | | | |
| | leadership | | | |
| | position in | | | |
| | market place | | | |
| | The | | | |
| | competitors | | | |
| | consider the | | | |
| | product line of | | | |
| | the | | | |
| | organization as | | | |
| | a direct threat | | | |
| | to their | | | |
| | business, | | | |

B) Technology, Tools and Methodologies (30 b)

| | | | | |
|---|---|---|---|---|
| Basic | The | Architecture | Hardware/Software | Significant |
| (Level 1) | methodologies, | centric | requirements | number of |
| | technologies | development | Communicated to | consultants |
| | and tools for | process has been | Infrastructure team | with |
| | the | defined | | experience in |
| | development of | Tools for product | | the |
| | the product | developments has | | technology |
| | have been | been defined & | | |
| | identified. | documented | | |
| | Technology | Technology & | | |
| | feasibility | Domain standard | | |
| | analysis | has been defined | | |
| | conducted, | and documented | | |
| | found to be | | | |
| | feasible to build | | | |
| | the product | | | |
| | with this tools, | | | |
| | technology and | | | |
| | methodology | | | |
| Established | The | Tools, standard | High available | Competency |
| (Level 2) | methodologies, | alignment with | deployment scenario | group is |
| | technologies | Enterprise level | defined | involved in |
| | and tools for | Product developed | | conducting |
| | the | as per model | | technology |
| | development of | driven | | related |
| | the product has | development | | trainings |
| | been | (MDD/MDI) | | |
| | standardized, | Tools for product | | |
| | and integrated | developments has | | |
| | into a standard | been standardized | | |
| | process | | | |
| | A process is in | | | |
| | place to track | | | |
| | changes in the | | | |
| | technology and | | | |
| | market | | | |
| | movements | | | |
| Differentiated | Product group | Ensure changes to | Product certified for | Training |
| (Level 3) | created | architecture are | deployment on | dashboard is |
| | Common | managed in | Multiple hardware | maintained |
| | service | cohesive and | and software | and presented |
| | platforms to | architected way | platform | to |
| | store core assets | Identified tools and | Application require a | management |
| | collection and | standards have | disaster recovery | periodically |
| | deployments | wide spread | deployment due to | |
| | | acceptance in | its business | |
| | | industry | criticality to the | |
| | | Tools for product | customer | |
| | | developments has | | |
| | | been automated | | |
| Leadership | The Group | Architecture is | Product supports | Training |
| (Level 4) | exhibits the | mature and market | multi tenancy | materials and |
| | characteristics | leader | capabilities | processes |
| | of early movers | The products have | | being |
| | or even | built in tools that | | automated |
| | pioneers in | are used as | | |
| | product | solution | | |
| | development | accelerator and | | |
| | | enhancing cost- | | |
| | | benefits to the | | |
| | | customers | | |

C) Product Code and Quality (30 c)

| | | | | |
|---|---|---|---|---|
| Basic | Coding standard | Continuous | Installation | People are |
| (Level 1) | available and is in | Integration is in | manual completed | trained in |
| | practice | place | | product code |
| | Tools for version | | | quality |
| | management is in | | | |
| | place | | | |
| | Test cases prepared, | | | |
| | ensure test coverage | | | |
| | Awareness of Code | | | |
| | quality created | | | |
| Established | Code | CQC (Code | Comply to | Competency |
| (Level 2) | walkthrough(reviews) | Quality | standard and | group is |
| | standardized and | Compliance) is | regulation of the | involved in |
| | practiced | 95% | industry | conducting |
| | Version management | (Rule | | technology |
| | tool religiously used | compliance, | | related |
| | Test cases automated | Total quality, | | trainings |
| | Final inspection | technical depth) | | |
| | conducted before | Total Quality | | |
| | every release | (Architecture | | |
| | | tangle index, | | |
| | | design quality, | | |
| | | testing quality, | | |
| | | code quality) is | | |
| | | 90% | | |
| | | Technical debt | | |
| | | ratio is less than | | |
| | | 10% | | |
| | | Automated Unit | | |
| | | Testing is in | | |
| | | practiced | | |
| Differentiated | Product or | CQC is 99% | Level of support | Training |
| (Level 3) | components shall | Automated | for infrastructure | dashboard is |
| | meet appropriate | Functional | | maintained |
| | quality criteria | testinge is in | | and |
| | throughout the life | practice | | presented to |
| | cycle | Total Quality | | management |
| | | (Architecture | | periodically |
| | | tangle index, | | |
| | | design quality, | | |
| | | testing quality, | | |
| | | code quality) is | | |
| | | 95% | | |
| | | Technical debt | | |
| | | ratio is less than | | |
| | | 5% | | |
| Leadership | Product released | Product | Infrastructure is | |
| (Level 4) | consistently with zero | architecture is | market leader | |
| | defects | market leader | | |
| | | Total Quality | | |
| | | (Architecture | | |
| | | tangle index, | | |
| | | design quality, | | |
| | | testing quality, | | |
| | | code quality) is | | |
| | | 99% | | |
| | | Technical debt | | |
| | | ratio is less than | | |
| | | 1% | | |

D) Release and Configuration Management (30 d)

| | | | | |
|---|---|---|---|---|
| Basic | Release | Stakeholders | Infrastructure for | People are |
| (Level 1) | planning of the | informed about | release is in place | trained in |
| | product is in | code freeze and | | release |
| | place | release | | management |
| | Product release | Configuration | | |
| | life cycle | Manager | | |
| | (Gold, Beta, | Identified | | |
| | Pre-Beta) | Release | | |
| | defined with | promotion should | | |
| | version number | be from Dev to | | |
| | as per | Test to Production | | |
| | guidelines | Code Versioning | | |
| | Configurable | is maintained for | | |
| | Items | each release | | |
| | identified, | | | |
| | processes in | | | |
| | place to | | | |
| | manage CI | | | |
| Established | Toll gate | Ease at which | Infrastructure for | Competency |
| (Level 2) | review | product moves | release management | group is |
| | completed | from one version | has been established | involved in |
| | before moving | to another | | conducting |
| | to ST & UAT | Upgrade path | | technology |
| | environment | from current | | related |
| | Release and | version to new | | trainings |
| | configuration | version | | |
| | management is | Release | | |
| | automated | management steps | | |
| | Management of | are automated & | | |
| | Post release | practiced | | |
| | issues | | | |
| | Baselines of | | | |
| | identified work | | | |
| | products | | | |
| | should be | | | |
| | established. | | | |
| Differentiated | Release | Automation of | Infrastructure for | People for |
| (Level 3) | management | development to | release management | release |
| | tools | build to release | has been | management |
| | standardized | management | institutionalized | has been |
| | Configuration | Automated | | institutionalized |
| | management | upgrade from | | |
| | tools | current version to | | |
| | standardized | new version | | |
| | Changes to | | | |
| | work products | | | |
| | under | | | |
| | configuration | | | |
| | management | | | |
| | shall be tracked | | | |
| | and controlled | | | |
| | Product | | | |
| | sustainment | | | |
| | services | | | |
| | offered to | | | |
| | customers | | | |
| | while the | | | |
| | product is | | | |
| | generally | | | |
| | available | | | |
| Leadership | Product | Release process | Infrastructure for | People process |
| (Level 4) | features sets | for architecture is | release management | are in market |
| | benchmarked | market leader | is market leader | leader |
| | in the industry | | | |

E) Usability, Interoperability & Performance (30 e)

| | | | | |
|---|---|---|---|---|
| Basic | Design, | User interface | Infrastructure for | People process |
| (Level 1) | development & | design and | usability is in place | for usability is |
| | testing processes | development in | The environment | in place |
| | are in place to | accordance with | for performance | Training on |
| | ensure | user experience | testing needs to be | Performance |
| | consistency and | heuristics. UI is | setup and the | testing best |
| | predictability | consistent and | performance | practices needs |
| | through the user | predictable | testing tools needs | to be conducted |
| | interface. | Product supports | to be installed. | and the team |
| | Basic | standard | | develops |
| | documentations | protocols | | expertise on |
| | on interfaces | | | performance |
| | available | | | testing tools. |
| | The performance | | | |
| | requirements for | | | |
| | the product are | | | |
| | captured and | | | |
| | workload | | | |
| | characterization | | | |
| | has been done. | | | |
| | The product is | | | |
| | developed so as | | | |
| | to meet the | | | |
| | performance | | | |
| | requirements | | | |
| | Performance | | | |
| | Testing is | | | |
| | conducted to | | | |
| | make sure that | | | |
| | the performance | | | |
| | requirements are | | | |
| | met | | | |
| | Performance | | | |
| | testing reports | | | |
| | analyzed and | | | |
| | recommendations | | | |
| | provided | | | |
| Established | Task flows | UI Design based | Infrastructure for | People for |
| (Level 2) | designed for | on requirements | usability has been | usability has |
| | usability. Uses | of real users. | established | been |
| | capabilities like | Designs and task | The dedicated | established |
| | session memory, | flow validation | environment for | The team |
| | smart defaults | with end users in | product | develops |
| | etc. | an iterative | benchmarking is | expertise on |
| | Interoperability | manner | set up. | performance |
| | standard are in | The product is | The performance | oriented |
| | place | architected and | engineering tools - | architecture and |
| | | design with | code profiling and | design |
| | | performance | performance | |
| | | requirements in | monitoring tools | |
| | | consideration. | are set up. | |
| | | The product has | | |
| | | been sized based | | |
| | | on the | | |
| | | performance | | |
| | | requirements. | | |
| | | Coding and | | |
| | | database design | | |
| | | are also done | | |
| | | based on the | | |
| | | performance | | |
| | | requirements. | | |
| | | The response | | |
| | | time break up for | | |
| | | each of the | | |
| | | technology | | |
| | | components are | | |
| | | available and the | | |
| | | product provides | | |
| | | performance | | |
| | | controls | | |
| Differentiated | User experience | The performance | Infrastructure for | Infrastructure |
| (Level 3) | fills an existing | based design | usability has been | for usability has |
| | gap or provides a | principles and | institutionalized | been |
| | superior | design patterns | | institutionalized |
| | experience | are incorporated | | The team |
| | compared to peer | in the | | develops |
| | product. The | development of | | expertise on |
| | desirability is | the product | | code |
| | indicated by | Code | | optimization |
| | comparing | Optimization and | | and database |
| | usability of the | Database tuning | | tuning |
| | product with | are carried out to | | |
| | peers as well as | improve the | | |
| | accounting for | performance of | | |
| | factors like | the product | | |
| | uniqueness, | | | |
| | persuasiveness, | | | |
| | online branding | | | |
| | and | | | |
| | differentiators | | | |
| | Product | | | |
| | performance | | | |
| | benchmarked | | | |
| Leadership | The product | User centered | Infrastructure for | People process |
| (Level 4) | creates a | design process | usability is market | are in market |
| | consistently | well integrated | leader | leader |
| | positive | with the product | | |
| | experience for | development | | |
| | end users. Has or | lifecycle. | | |
| | shows potential | Innovative User | | |
| | of creating a cult | Experience ‘firsts’ | | |
| | following. User | set a trend for | | |
| | loyalty is strong | others to follow | | |
| | and the product | Product is used | | |
| | becomes a | as benchmark for | | |
| | statement rather | Security | | |
| | than a utility | Standards in the | | |
| | The product is | market segment | | |
| | used as a | Some of the | | |
| | benchmark for | performance | | |
| | Performance | design | | |
| | standards in the | components are | | |
| | market segment. | patented. The | | |
| | | product is | | |
| | | capable of | | |
| | | adopting to new/ | | |
| | | futuristic | | |
| | | technologies | | |

F) Secure Engineering & Supply Chain (30 f)

| | | | | |
|---|---|---|---|---|
| Basic | The product provides | Product has incorporated | Infrastructure | Background |
| (Level 1) | role based access to the | security in requirement | for Secure | check & |
| | users | and architecture | engineering | NDA are |
| | Supply chain risk | | is defined | done for |
| | identification, | | Risk based | employees |
| | assessment, and | | procedure for | and |
| | prioritization shall be | | physical | contractors |
| | completed | | security & | Product team |
| | The Product has | | access | is aware and |
| | identified Security | | control are in | trained in |
| | Requirements & | | place | SSA |
| | collected as per | | Infrastructure | processes & |
| | requirement collection | | for System | Supply Chain |
| | | | Security & | integrity |
| | | | Network | Information |
| | | | security are | Security |
| | | | in place | training are |
| | | | | conducted for |
| | | | | employees |
| Established | The Product is | Threat and risk models | Dedicated | Training |
| (Level 2) | developed using Secure | are created in the context | infrastructure | Secure |
| | Coding Practices. | of the product | for Security | Engineering |
| | Security Testing done & | architecture type and the | Testing is in | & Supply |
| | sign-off from Security | target deployment | place | Chain |
| | CoE (Source Code | environment | | integrity has |
| | Analysis and VAPT) | Run time protection | | been |
| | Supply Chain | techniques are | | performed |
| | information systems | established | | and records |
| | shall protect confidential | | | documented |
| | data through an | | | (SSA |
| | appropriate set of | | | Identifying |
| | security controls | | | Security |
| | A Trusted Technology | | | Requirements |
| | Provider evaluates | | | SSA Secure |
| | supplied components to | | | Design |
| | assure that they meet | | | Principles |
| | specified quality and | | | SSA Security |
| | integrity requirements | | | Review of |
| | The Product has | | | Architecture |
| | developed Secure | | | SSA Secure |
| | Deployment Guidelines | | | Coding |
| | Documented processes | | | Practice |
| | for supply chain security | | | SSA Security |
| | are in place and tailored | | | Testing |
| | | | | SSA Secure |
| | | | | Deployment |
| | | | | Guidelines) |
| Differentiated | Secure | The Product incorporates | Infrastructure | Training for |
| (Level 3) | development/engineering | Domain Specific | is updated as | Secure |
| | methods are specified | Security Requirements. | per threat | Engineering |
| | and refined to best fit the | Product comply to | landscape | & Supply |
| | development/engineering | Domain Specific | | chain has |
| | characteristics of the | Security Standards | | been |
| | target product/domain | Secure | | automated |
| | Secure development | development/engineering | | Peoples are |
| | techniques integrated | practices and techniques | | certified on |
| | into the vendor's | including the guidance | | Software |
| | development method and | and tools which support | | Security |
| | inform and guide the test | them, are periodically | | |
| | processes. | reviewed and updated as | | |
| | | appropriate in light of | | |
| | | changes in the threat | | |
| | | landscape | | |
| Leadership | Leader in Secure | Leader in Secure | Infrastructure | People for |
| (Level 4) | engineering & Supply | engineering & Supply | for secure | secure |
| | Chain processes | Chain architecture | engineering | engineering |
| | | | is market | is market |
| | | | leader | leader |

G) Intellectual Property (30 g)

| | | | | |
|---|---|---|---|---|
| Basic | Product team | Architecture group | Infrastructure group | Basic training |
| (Level 1) | aware about the | work towards | work towards | on IPR is in |
| | IPR concepts, | innovations | innovations | place |
| | already | | | Awareness of |
| | initiated | | | IPR created |
| | process of | | | |
| | identifying IPR | | | |
| | components | | | |
| | Guidelines for | | | |
| | licensing of | | | |
| | product is in | | | |
| | place | | | |
| Established | Product team | Team has | Team has identified | Team has |
| (Level 2) | fully | identified | infrastructure | identified |
| | conversant with | architecture | components to be | infrastructure |
| | IPR concepts | components to be | patented | components |
| | All components | patented | | to be patented |
| | for IPR filing | | | |
| | has been | | | |
| | identified | | | |
| | IPR filing of | | | |
| | components has | | | |
| | been initiated | | | |
| | 30% of the total | | | |
| | components | | | |
| | developed are | | | |
| | patentable | | | |
| | Product follows | | | |
| | guidelines for | | | |
| | licensing | | | |
| | religiously | | | |
| Differentiated | Product team is | Team has made | Team has made | Team has |
| (Level 3) | working | considerable | considerable | made |
| | keeping | progress in patent | progress in patent | considerable |
| | innovation in | filing, all | filing, all patentable | progress in |
| | mind | patentable items | items are | patent filing, |
| | 60% of the total | are documented in | documented in | all patentable |
| | components | Invention | Invention Disclosure | items are |
| | developed of | Disclosure form | form and reviewed | documented |
| | the product are | and reviewed from | from IPR Cell and | in Invention |
| | identified as | IPR Cell and | submitted in Patent | Disclosure |
| | patentable | submitted in Patent | office | form and |
| | Team has made | office | | reviewed |
| | considerable | | | from IPR Cell |
| | progress in | | | and submitted |
| | patent filing, all | | | in Patent |
| | patentable | | | office |
| | items are | | | |
| | documented in | | | |
| | Invention | | | |
| | Disclosure | | | |
| | form and | | | |
| | reviewed from | | | |
| | IPR Cell and | | | |
| | submitted in | | | |
| | Patent office | | | |
| Leadership | Product is | Product is | Product is | Product is |
| (Level 4) | considered as | considered as | considered as market | considered as |
| | market leader | market leader in | leader in patent | market leader |
| | in patent filing | patent filing | filing infrastructure | in patent |
| | 80% of the total | architecture point | point of view | filing people |
| | components | of view | | point of view |
| | developed of | | | |
| | the product are | | | |
| | identified as | | | |
| | patentable | | | |

In another aspect of the present invention, the maturity score of each Key focus area (30) at each level is computed. For the said purpose, software product maturity model 100 includes a computation system that computes the maturity score based on weights assigned to each of the key focus areas and assessment score entered by the assessor further based upon his assessment findings.

The computation system firstly provides weightage to each key focus area at each level depending upon their significance in the corresponding maturity level (10). Referring now to Table 2 below, an example of weights being assigned to each of the key focus areas (30) is illustrated. For example, Product planning (30a) is assigned a score of 8 at the basic level since here the product roadmap is to be defined and clarity that has to be developed on product functionality and positioning is still in a nascent stage, which establishes its utmost significance at Basic level. Similarly, the Intellectual Property (30d) is being assigned a weight of 8 at the leadership level since now the product has emerged as a market leader from the perspective of patent filing.

| | Clarity on | | | | |
|---|---|---|---|---|---|
| | product | | | | |
| | functionality & | | Securing | | |
| | positioning | | engineering and | Legally protected | |
| | Clear product | Processes, tools, | Supply Chain for a | industry leading | |
| | dev methodology | technologies are | high performing | end user | |
| Theme | & tools identified | stable | product | experience | |
| Product Planning | 8 | 5 | 4 | 3 | 20 |
| Technology, Tools & Methodology | 7 | 7 | 4 | 2 | 20 |
| Product & Code Quality | 6 | 6 | 4 | 4 | 20 |
| Release & Configuration | 6 | 5 | 4 | 5 | 20 |
| Management | | | | | |
| Usability, Interoperability & | 3 | 3 | 6 | 8 | 20 |
| Performance | | | | | |
| Secure Engineering & Supply Chain | 3 | 5 | 7 | 5 | 20 |
| Intellectual Property | 2 | 4 | 6 | 8 | 20 |
| Total | 35 | 35 | 35 | 35 | 140 |

Accordingly maturity score of each particular key factor area at a particular level is calculated based on the score and category weight of key focus area and assessed at what level the software product is with respect to the weightage given and maturity score is computed.

Secondly, the assessor makes his assessment based on two criteria's, i.e. ‘Compliance’ and ‘Non-compliance’. This attribute enhances the accuracy of assessing the software product wherein the software product is assessed for each of the conformance requirements. A comprehensive checklist for all four levels is prepared covering all the four competencies (20) and seven key focus areas (30) to assess for conformance requirements appropriate to the software product that needs to be assessed. The checklist items can be applicable or not-applicable for a specific software product. All applicable checklist items are evaluated to check if the specific software product meets or don't meets the criteria. Any irrelevant conformance requirement for a particular software product is excluded from the checklist, thereby reducing any chance of discrepancy in assessing the software product.

Another attribute of the present invention includes one to ‘N’ conformance requirement wherein each of the conformance requirement is assessed 4×7×4 (4 maturity levels, 7 key focus areas, and 4 competency areas) to arrive at a conclusion on the maturity level of the software product.

The software product computation involves reviewing the product and documentations by the assessor prior to the assessment. The assessment is based on the checklist that includes a set of questionnaires and is analyzed based on whether the software product is compliant with the set of requirements. The set of questions are gauged by collecting data that supports each of the conformance requirements applicable for assessment of the software product.

To conduct the assessment based on the checklist, the assessor needs to provide ratings based on each question. In order to achieve a particular level, any software product is required to meet all the checklist criteria of that particular level as well as of all the levels below it.

The maturity scores are then computed for each key focus area and aggregated to identify the maturity level of the software product. In order to move from a lower maturity level to a higher maturity level in a hierarchy, all the requirements listed in the lower maturity levels should be met. The threshold score is determined for each level, and only if the score observed at each level is found above the threshold for that level, they get aggregated to obtain a final maturity score. For example, if the score at established level is found lower than the threshold decided for this level, the aggregated score will include scores only of the basic maturity level.

Those skilled in the art will recognize that the basic objectives achieved by the present invention need not have attributes as described above having fixed number of maturity levels, fixed number of key focus areas, and fixed number of key competency areas, and may vary based on the evaluation needs and the type of software product that is to be evaluated.

Reference will now be made in detail to the exemplary embodiment(s) of the present invention, as illustrated in the accompanying drawings. Whenever possible, the same reference numerals will be used throughout the drawings to refer to the same or like parts.

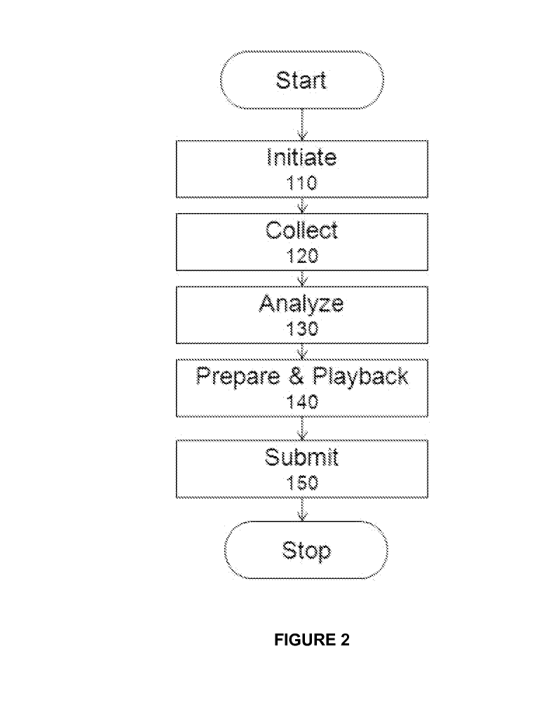

Turning to FIG. 2, a flow diagram 100 depicting the process of assessing a software product is illustrated. The assessment process includes five stages, the five stages being Initiate stage 110, Collect stage 120, Analyze stage 130, Prepare & Playback stage 140, and Submit stage 150, and the duration for the assessment process to conclude is approximately 5 weeks from the start date. At the initiate stage 110, the process includes initiating management approvals, forming assessment team, preparing processes, and sharing initial documents. At the collection stage 120, the process includes collecting business drivers, conducting product demos, collecting architecture, documentation and assessing the product maturity model. At the Analyzing stage 130, the four key competency areas of Process, Architecture, Infrastructure, and People are analyzed. At the Prepare & Playback stage 140, the summarizing of the analysis obtained, preparing draft assessment reports are worked upon. The submit stage 150 includes preparing and submitting the final assessment report and based on the evaluation recommending for further improvements.

As an example, at Basic level 20a, for a key focus area, say, product planning, the checklist comprising questions on a competency area, say, process, may be:

Is the product feasible to develop from functional point of view?

Is the product estimated at different stages of lifecycle using function points and reviewed?

Is the pricing model and pricing in line with market expectation?

At Leadership level 10d for the same key focus area i.e. Product planning, the checklist on a process perspective could comprise questions such as:

Is the product performing as #1 product in the market?

Has the product occupied leadership position in market place?

For key focus area Usability, Interoperability & Performance, at a Differentiated level 10c, the checklist based on architecture, the questionnaire could be:

Has the product been sized based on the performance requirements?

Does code optimization and Database tuning carried out to improve the performance of the product?

For the same key focus area i.e. Usability, Interoperability & Performance, but at a Leadership level 10d, the checklist based on same dimension i.e. architecture, the questionnaire could be:

Does user center designed process integrate with the product development lifecycle?

Is the product capable of adopting to new/futuristic technologies?

The answers for all the questionnaires are marked as either ‘Compliance’ or ‘Non-compliance’ based on whether the software product is compliant or non-compliant to that specific conformance requirement.

Based upon above exemplary questions if it is ascertained that all the compliance items are met, it would be defined ‘Compliant’ and further based on the weightage, if it is concluded that the software product meets the criteria of the Basic level 10a, the assessment will then be proceeded to the next level i.e. Established level 10b and thereon till Leadership level 10d. However, if the software product has not been fully institutionalized based on the outcome of the assessment, assessment for the next maturity levels would not be performed and remedial measures would be taken to ensure the software product meets the criteria of Basic level 10a.

The checklist prepared at each maturity level for each key factor area is based on the four competency areas of Process, Architecture, Infrastructure, and People. For each of the conformance requirement, at each stage it is assessed if the checklist needs to be edited by either deleting or adding few questions based on the software product that needs to be assessed. The checklist includes all the questions that are required to be assessed and marked as ‘applicable’. The questions that need not have to be assessed are marked as ‘Not Applicable’ and hence will not be assessed for the software product. Next, as discussed above, the assessment on whether the software product meets the checklist criteria is assessed. If the software product meets the criteria, the same would be marked as ‘Conformance criteria met’ and would be further assessed on other checklist questionnaires to check the criteria assessment. Once the entire checklist is assessed, weightage would be provided based on the maturity level, the key focus area, and the competency area. If the software product does not meet the criteria, the same would be marked as ‘Conformance criteria not met’. The result of the assessment is then summarized and a set of recommendations are made for the software product, if the software product does not fulfill the three maturity levels of Basic, Established, and Differentiated levels. For example, if a software product does not meet the Differentiated level of maturity, a certain set of recommendations would be made based on identifying the conformance requirements that were not compliant and accordingly suggestions would be provided on overcoming those conformance requirements.

Example embodiments of the process and components of the current subject matter have been described herein. As noted, these example embodiments have been described for illustrative purposes only, and are not limiting. Other embodiments are possible and are covered by the invention. Such embodiments will be apparent to persons skilled in the relevant art(s) based on the teachings contained herein. Thus, the breadth and scope of the current subject matter should not be limited by any of the above-described exemplary embodiments, but should be defined in accordance with the following claims and their equivalents.

We claim:

1. A method for evaluating maturity level of a software product at least one maturity level in dimensions of at least one Key focus (KFA) area, at least one competency area, at least one maturity level, the method comprising:
providing a category weightage to at least one key focus area (KFA) for at least one maturity level, the weightage being based on its significance at a particular maturity level;
providing by at least one assessor product maturity model ratings based on ratings score calculated for each KFA based on a predefined checklist comprising of at least one question of a questionnaire;
calculating the maturity score of the each KFA based on the ratings score and the category weightage of said at least one KFA; and
for the maturity score for each level determined above a threshold score, aggregating the maturity score to the maturity scores determined for each maturity level below said level to obtain a single product maturity score, wherein at least one of the providing, calculating, and aggregating is performed by a processor.

2. The method as claimed in claim 1, wherein the competency area is selected from a group consisting of process, architecture, infrastructure and people.

3. The method as claimed in claim 1, wherein the key focus area is selected from a group consisting of Product Planning, Technology, Tools & Methodology, Product Code & Quality, Release & Configuration Management, Usability, Security & performance, Secure Engineering & Supply Chain, Intellectual Property Rights (IPR).

4. The method as claimed in claim 1, wherein the maturity level is selected from a group consisting of basic level, established level, differentiated level, and leadership level.

5. The method as claimed in claim 1, wherein checklist items are ascertained to determine their applicability for the software product.

6. The method as claimed in claim 1, wherein the assessor provides the rating score based on options of “compliance” and “non compliance” of the product to corresponding question in the checklist.

7. The method as claimed in claim 1, wherein the checklist is provided for all four levels covering all the four competences and seven KFA of software product maturity model (SPMM).

8. The method as claimed in claim 1, wherein in order to achieve a particular maturity level, the product is required to meet all the checklist criteria of that particular maturity level as well as of all the levels below it.

9. A system for evaluating maturity level of a software product at least one maturity level, the maturity score being computed in terms of at least one Key focus (KFA) area, at least one competency area, at least one maturity level, and at least one assessment reading, the system comprising:
a memory; and
a processor coupled to the memory configured to execute software instructions to cause following steps:
providing a category weightage to at least one key focus area (KFA) for at least one maturity level, the weightage being based on its significance at a particular maturity level;
providing by an assessor product maturity model ratings based on ratings score calculated for each KFA based on a predefined checklist comprising of at least one question of a questionnaire;
calculating the maturity score of that KFA based on the ratings score and category weightage of said at least one KFA; and
for the maturity score for each level determined above a threshold score, aggregating the maturity score to the maturity scores determined for each maturity level below said level to obtain a single product maturity score.

10. The system as claimed in claim 9, wherein the competency area is selected from a group consisting of process, architecture, infrastructure and people.

11. The system as claimed in claim 9, wherein the key focus area is selected from a group consisting of Product Planning, Technology, Tools & Methodology, Product Code & Quality, Release & Configuration Management, Usability, Security & performance, Secure Engineering & Supply Chain, Intellectual Property Rights (IPR).

12. The system as claimed in claim 9, wherein the maturity level is selected from a group consisting of basic level, established level, differentiated level, and leadership level.

13. The system as claimed in claim 9, wherein a checklist is provided for all four levels covering all the four competences and seven KFA of software product maturity model (SPMM).

14. The system as claimed in claim 9, wherein checklist items are ascertained to determine their applicability for the product, wherein the assessor provides the rating score based on options of “compliance” and “non compliance” of the product to corresponding question in the checklist.

15. The system as claimed in claim 9, wherein in order to achieve a particular level, the product is required to meet all the checklist criteria of that particular level as well as of all the levels below it.
